(19) United States
(12) Patent Application Publication
(10) Pub. No.: US 2007/0236462 A1
(43) Pub. Date: Oct. 11, 2007

(54) Electronic device

(76) Inventors: Quintin Morris, Brooklyn, NY (US); Katrika Woodcock, Brooklyn, NY (US); Jorg Schlieffers, Streatley-on-Thames (GB); Christopher N. Crawford, Glen Clove, NY (US); Robert J. Kowalski, Commack, NY (US); Salvatore A. Spiteri, North Babylon, NY (US)

Correspondence Address: FAY KAPLUN & MARCIN, LLP, 15O BROADWAY, SUITE 702, NEW YORK, NY, 10038, US

(21) Appl. No.: 11/394,316

(22) Filed: Mar. 30, 2006

(51) Int. Cl. G09G 5/00

(52) U.S. Cl. 345/169

(57) ABSTRACT

A device comprises a housing including an internal chamber and an external keypad mounting area and a primary printed circuit board mounted within the internal chamber along with a secondary printed circuit board mounted on the external keypad mounting area and electrically coupled to the primary printed circuit board in combination with a plurality of switches corresponding to the keys of the key pad over the secondary printed circuit board and a key pad including a plurality of keys mounted in a predetermined alignment over the plurality of switches so that the secondary printed circuit board is between the key pad and a surface of the external key pad mounting area and the switches are between the secondary printed circuit board and the key pad.

### BACKGROUND

Users of mobile electronic devices often carry them throughout the day, while handling food and drinks, etc. Such use makes these devices more susceptible to damage from, for example, spills which penetrate housing openings adjacent to the keypad, etc. The housing openings also make the device susceptible to environmental contaminants, such as dust, moisture, etc.

As shown in FIGS. 1 and 2, a housing 2 of a conventional mobile device 1 includes a keypad 12 operating switches 16 which typically reside on a main printed circuit board (“PCB”) 20 located within the housing 2 of the device 1. An actuator or pin 10 of each of the keys 8 of the keypad 12 penetrates a keypad supporting surface 15 of the housing 2 through a separate opening 6 to reach a corresponding switch 16 on the PCB 20. The actuators 10 are moved up and down into and out of engagement with the corresponding switches 16 as the keys are depressed. However, accommodating the movement of the actuators 10 through the holes 6 makes it difficult to maintain an adequate seal around each of the holes 6 which may lead to structural and/or electrical damage to the mobile device 1.

### SUMMARY OF THE INVENTION

The present invention is directed to a device comprising a housing including an internal chamber and an external keypad mounting area and a primary printed circuit board comprising expensive circuitry and components mounted within the internal chamber in combination with a secondary, simple and inexpensive printed circuit board mounted in the external keypad mounting area, the secondary printed circuit board being electrically coupled to the primary printed circuit board and a plurality of switches corresponding to the keys of the key pad over the secondary printed circuit board and a key pad including a plurality of keys mounted in a predetermined alignment over the plurality of switches so that the secondary printed circuit board is between the key pad and a surface of the external key pad mounting area and the switches are between the second printed circuit board and the key pad. Those of skill in the art will understand that the present invention reduces the chance that the primary, expensive printed circuit board will be damaged.

### BRIEF DESCRIPTION OF THE DRAWINGS

FIG. 1 shows a conventional mobile device housing and keypad support;

FIG. 2 shows a conventional keypad assembly architecture;

FIG. 3 shows a mobile device according to the present invention;

FIG. 4 shows an exemplary embodiment of a keypad arrangement according to the present invention;

FIG. 5a shows a front view of an external printed circuit board according to the present invention;

FIG. 5b shows a rear view of the external printed circuit board of FIG. 5a;

FIG. 6 shows an exemplary embodiment of an integration of a mobile device housing, including the keypad arrangement, and a main printed circuit board according to the present invention;

FIG. 7 shows a side view of the mobile device shown in FIG. 6; and

FIG. 8 shows an exemplary embodiment of a method according to the present invention.

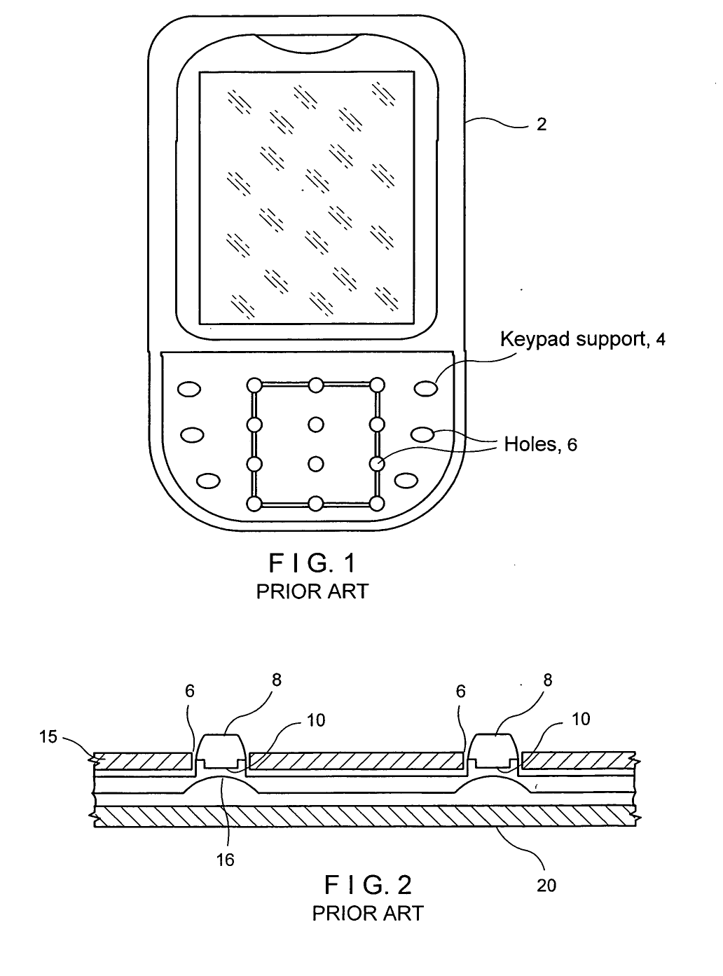

### DETAILED DESCRIPTION

The present invention may be further understood with reference to the following description and the appended drawings, wherein like elements are referred to with the same reference numerals. The present invention will be described with reference to mobile electronic devices (e.g., PDA's, palm sized personal computers, cellular telephones, global positioning systems (GPS), bar code scanners, digital imagers, radio frequency identification (RFID) devices, etc.). However, those skilled in the art will understand that the integrations according to the present invention are equally suited for any electronic device utilizing a keypad or other plurality of buttons, such as, for example, mobile and stationary electronic devices including telephones, printers, copy machines, etc.

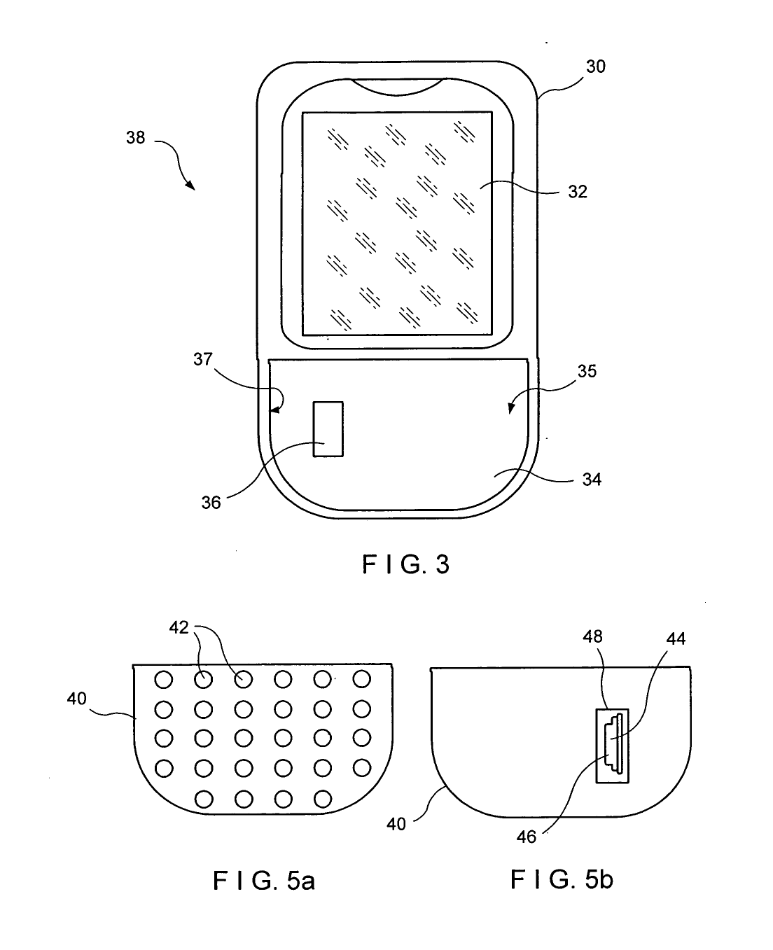

FIG. 3 shows a mobile device 38 according to the present invention including a housing 30. As would be understood by those skilled in the art, the housing 30 may be made from any suitable material(s) such as aluminum, silicon, polymer, etc., and may be formed by, for example, blow molding, injection molding, etc. Outer walls of the housing 30 define an internal chamber 31, shown in FIG. 6, in which internal components (e.g., a primary PCB 60, a battery, etc.) of the device 38 are enclosed. As would be understood by those skilled in the art, components are included within the chamber 31 for protection from environmental conditions external to the housing 30.

The housing 30 according to this embodiment includes a first opening 32 which, in this case, is a cutout sized and shaped to present for access or observation by a user an active surface of a display 33 (e.g., a passive display or touchscreen) while the balance of the display 33 is received within the chamber 31 of the housing 30. An entire perimeter of this opening 32 is sealed in a conventional manner to protect the components within the chamber 31 of the housing 30 from any liquid or other potentially harmful substance with which the display 33 may come into contact. The housing 30 further includes a keypad receiving cavity 35 formed by a keypad supporting surface 34 and surrounding side walls 37. However, it will be understood by those of skill in the art that the keypad of the present invention may be positioned on any surface of the housing 30, whether or not a cavity such as the cavity 35 is included. Those skilled in the art will understand that the cavity 35 is preferably sized and shaped to accommodate a keypad arrangement 50 which includes, for example, an external circuit board 40, a keypad 52 comprising a plurality of keys 53 coupled to a flexible sheet 54, and a frame 56, as shown in FIG. 4. As would be further understood by those skilled in the art, this exemplary keypad arrangement 50 may be replaced by any structure supporting a plurality of buttons adjacent to one another. Furthermore, as would be understood by those skilled in the art, the keypad supporting surface 34 may be formed in any conventional manner integrally with the rest of the housing 30 or as a separate element which is later joined to the housing 30.

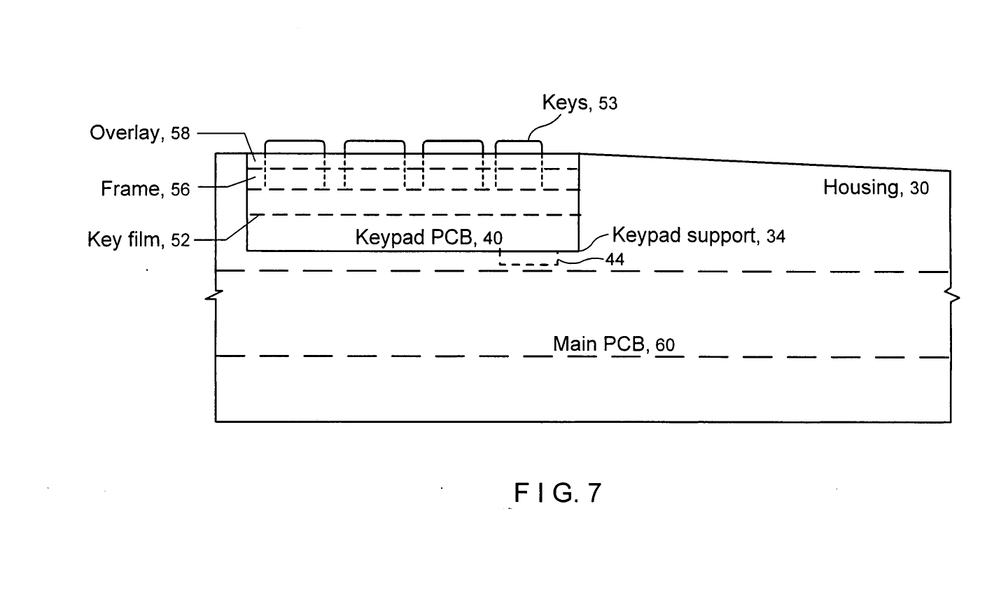

The housing 30 includes a second opening 36 extending through the keypad supporting surface 34 allowing electrical communication between components in the keypad receiving cavity 35 and the primary PCB 60 which is located within the housing 30, as shown in FIG. 7. In this manner, an electrical connection through the second opening 36 is sealed, allowing the cavity 35 to be sealed more easily and making the seal more rugged. Preferably, the second opening 36 is defined in the keypad supporting surface 34 of the cavity, although it may alternatively be defined in a side wall 37 of the cavity 35 or in any other suitable surface of the housing 30. In the mobile device 38 according to this embodiment of the invention, each key 53 of the keypad arrangement 50 is positioned over a corresponding switch 42 on a secondary external circuit board 40 which is located within the keypad receiving cavity on the same side of the keypad supporting surface 34 as the keypad 52. Alternatively, as would be understood by those skilled in the art, the secondary external circuit board 40 may include a number of switches 42 less than the number of keys 53 with a combination of switches activated at any given time indicating which key 53 has been actuated.

FIG. 4 shows an embodiment of a system according to the present invention. The keypad supporting surface 34 includes the second opening 36, which defines an entry site into the housing 30. The secondary external circuit board 40 is placed over the keypad supporting surface 34, so that a data connector 44 aligns with the second opening 36. According to an embodiment of the present invention, the secondary external circuit board 40 may be secured to the keypad supporting surface 34 using adhesive.

The keypad 52 is placed over the secondary external circuit board 40 so that a plurality of keys 53 thereof, which may be depressed by a user to enter input to the mobile device, are in a desired alignment with the switches 42. In one embodiment of the present invention, the keys 53 are mechanically coupled to a flexible sheet (e.g., the keypad film 54) which may be composed of any of a number of materials, including but not limited to rubber, plastic, which can flex without breakage or fatigue when a key 53 is pressed. Accordingly, openings in the keypad film 54 are preferably minimized or, if possible, eliminated to protect the secondary external circuit board 40 from foreign substances with which the keypad 52 may come in contact. In one embodiment of the present invention, the keys 53 are coupled to the keypad film 54 by an adhesive, male/female mating, etc. According to another embodiment, the keys 53 are formed integrally with the keypad film 54.

As further shown in FIG. 4, an optional frame 56 which is placed over the keypad 52 includes a number of holes 57 selected to accommodate the keys 53 of the keypad 52. The frame 56 stabilizes the keypad 52 and further protects the secondary external circuit board 40 from spills, etc. As would be understood by those skilled in the art, the frame 56 may be formed from any of a variety of materials, including plastic, metal, etc. In one embodiment of the present invention, the frame 56 is secured to the housing 30 via one or more screws (not shown). For example, in this embodiment, a plurality of screws are placed around a perimeter of the frame 56, passing through the keypad 52 and the secondary external circuit board 40 and into the housing 30. An overlay 58, including holes 59, is then placed over the frame 56 to conceal the screws. In another embodiment of the present invention, other coupling devices may be used in lieu of or in addition to the screws to secure the frame 56 to the housing 30. For example, one or more tabs extending from the housing 30 may be flexed over the frame 56, or the frame 56 may be bonded to the housing 30 using adhesive.

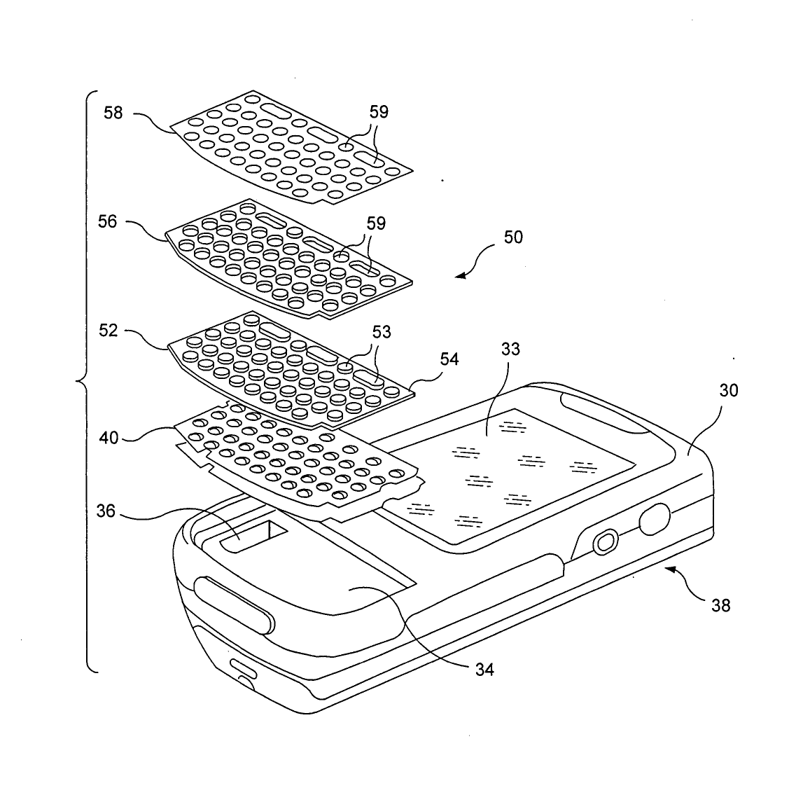

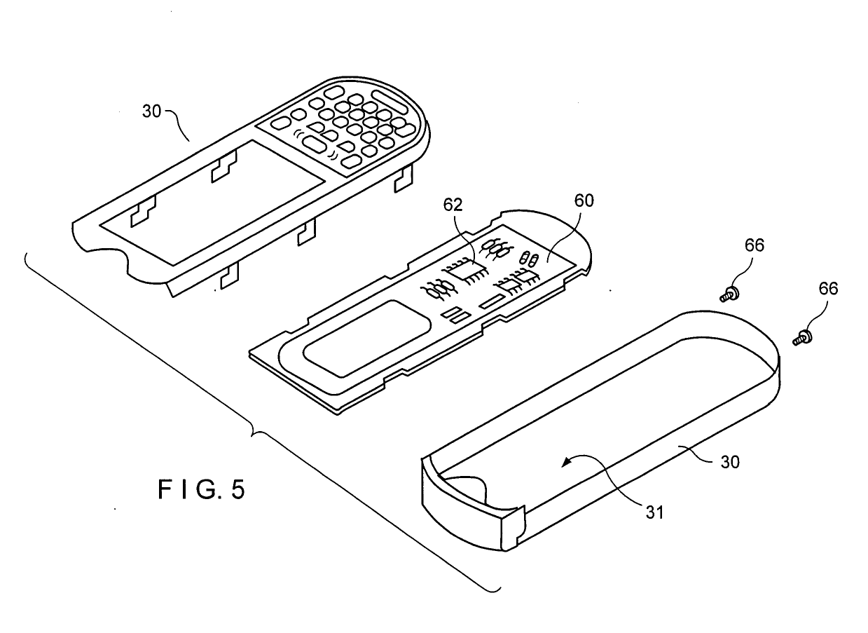

As shown in FIG. 5b, the secondary external circuit board 40 includes the data connector 44 (e.g., a multi-pin connector) or other electrical connection including multiple data lines. The second opening 36 is preferably sized and shaped to accommodate the data connector 44 or a cable extending therefrom so that the data connector 44 or cable may be electrically connected to corresponding contacts on the primary PCB 60 or to contacts on a component coupled thereto so that electrical signals corresponding to the actuation of the keys 53 may be transferred to the primary PCB 60.

In one embodiment of the present invention, the connector 44 is a pin and socket connector including a plurality of data pins 46. However, it will be understood by those of skill in the art that any of a variety of connectors may be used. As shown, the connector 44 is sized to fit comfortably within the second opening 36 with a surface of the secondary external circuit board 40 lying flush against the keypad supporting surface 34 of the housing 30. In one exemplary embodiment, an adhesive membrane may seal the secondary external circuit board 40 to the housing 30. Thus, the port 36 is completely enclosed, and the possibility for liquid or other substances to pass therethrough is minimized.

Thus, the keypad supporting surface 34 contains only a single opening (second opening 36) to accommodate all of the electrical connections between a plurality of keys 53 and the primary PCB 60 and a seal 48 extends around the entire perimeter of the second opening 36 so that any liquid spilled on the keypad arrangement 50 is prevented from passing through the keypad supporting surface 34. This seal 48 is more effective than the seals in the conventional keypads as there is no relative movement between the seal 48 and the components passing through the second opening 36. The second opening 36 may be any size and shape, although it is preferable for the second opening 36 to be as small as possible while accommodating the desired connection arrangement. For example, according to an embodiment of the present invention, the second opening 36 is approximately 50 mm². The second opening 36 according to this embodiment is substantially rectangular as this facilitates manufacturing the housing 30 and sealing the second opening 36. Specifically, the second opening 36 is preferably lined with a sealant (e.g., latex, urethane, silicone, fibrin, etc.) to prevent any substance from passing therethrough.

FIG. 5a shows a front view of the secondary external circuit board 40 which preferably handles only those functions necessary to transfer data between the keypad 52 and the primary PCB 60. Thus, if liquid spilled on the keypad 52 penetrates past the keypad film 54, the secondary external circuit board 40 may be shorted out. However, the liquid will be prevented from passing across past the keypad supporting surface 34 to the primary PCB 60. Thus, spills will be prevented from damaging the major components of the device 28 and, if liquid does pass through the keypad film 54 shorting out the secondary external circuit board 40, the device 28 may be repaired by simply replacing this component. According to the present invention, the secondary external circuit board 40 is separate and distinct from the primary PCB 60 while electrically coupled thereto. The secondary external circuit board 40 may reside on an outer surface of the housing 30, such as on the keypad supporting surface 34. As described above, a plurality of switches 42 are formed on the secondary external circuit board 40 to operate in conjunction with keys.

FIG. 6 shows an embodiment where the keypad assembly, integrated onto an upper portion of the housing 30, is conjoined with the primary PCB 60. The keypad assembly may, for example, be pieced together as discussed above with respect to FIG. 5. Circuitry 62 associated with the primary PCB 60 includes, for example, a connector which complements the connector 44 of the secondary external circuit board 40 so that this connector may be mated with the connector 44 to electrically couple the secondary external circuit board 40 to the primary PCB 60. A lower portion of the housing 30 may then be joined with the upper portion and secured (e.g., with screws 66) to seal the chamber 31.

FIG. 7 further exemplifies an integration of the keypad arrangement 50 into a mobile device according to an embodiment of the present invention. As shown, the primary PCB 60 lies within the housing 30 with the secondary external circuit board 40 resting on an outside of the keypad supporting surface 34 which, in this embodiment, is inset with respect to an outer surface of the housing 30. The connector 44 extends through the second opening 36 and is electrically coupled to the main PCB 60 and the keypad 52 resides over the secondary external circuit board 40. The frame 56 and overlay 58, respectively, reside over the keypad 52. As shown, the keys 53 may extend past the frame 56 and the overlay 58, allowing the size of the keypad 52 to be increased to facilitate depression of the desired keys 53.

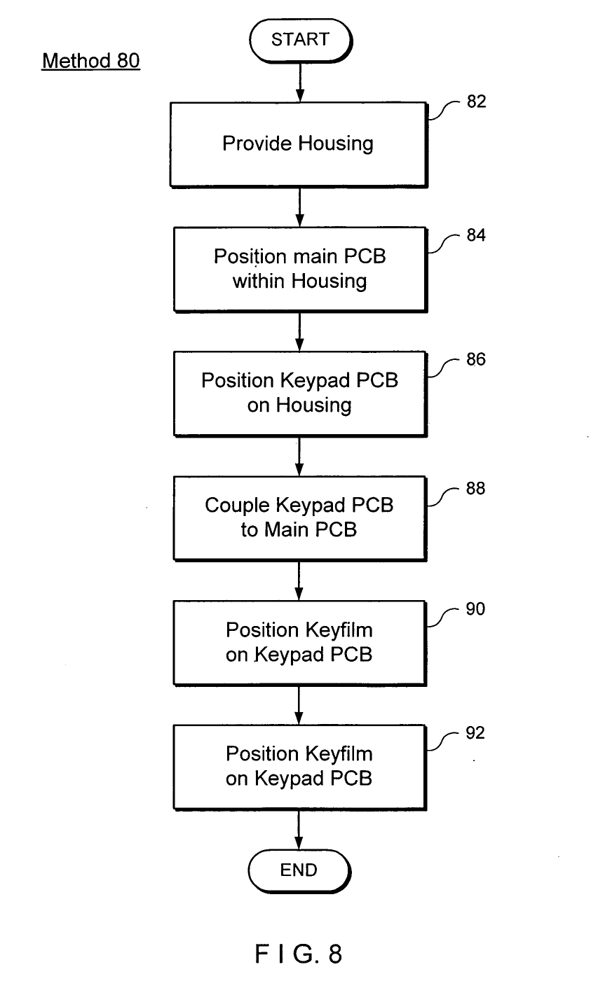

FIG. 8 shows an exemplary method 80 for manufacturing a keypad assembly according to an embodiment of the present invention. In step 82, a housing 30 is provided which may, for example, be a monocoque design, formed of one continuous piece of material. Alternatively, the housing 30 may include two or more pieces (e.g., a top portion and a bottom portion) which are fused or otherwise fastened to one another.

In step 84, the primary PCB 60 is positioned within the housing 30 and, in step 86, the secondary external circuit board 40 is positioned on the housing 30 with the connector 44 aligned with the second opening 36 and corresponding circuitry 62 (e.g., the complementing connector) of the primary PCB 60 for electrical connection to the primary PCB 60 (step 88).

In step 90, the keypad 52 is positioned in a desired alignment on the secondary external circuit board 40 as described above and, in step 92, the frame 56 is positioned on the keypad 52 and secured to the housing 30 by, for example, screws, adhesive, fasteners, etc. If necessary, an overlay 58 is positioned over the frame 56 to increase an aesthetic value of the keypad assembly.

An advantage of the keypad assembly of the present invention is that it saves a considerable amount of space. For example, because the secondary external circuit board 40 is separate from the primary PCB 60, the primary PCB 60 may be made smaller allowing size of the chamber 31 and the size of the housing 30 to be reduced. Alternatively or additionally, additional circuitry may be placed on the primary PCB 60, enabling the mobile device 38 to perform an increased number of functions without increasing the size of the primary PCB 60 and the chamber 31. Also, a greater number of keys 53 may be included in the keypad arrangement, because there is more space available for the larger switches 42 or for an increased number of switches 42. For example, in some smaller conventional keypad assemblies each key represents a number of letters and/or numbers requiring the user to press keys numerous times when entering a single character. Embodiments of the present invention may allow certain of these keypads to be expanded with separate keys for a larger number of characters. In addition, the present invention may reduce a number of configurations of the primary PCB 60.

From the above description of the exemplary embodiments, those of skill in the art will understand that the present invention may reduce space needed for bosses on the keypad area of a mobile device, allowing for the greater number and/or larger keys 53. The mobile device is designed with the knowledge that space is needed for fastening components of the device, e.g., halves of the housing 30, the keypad, etc. According to the present invention, fasteners (e.g., screws) may secure the keypad to the cavity 35 and an upper half of the housing 30.

It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A device, comprising:
a housing including an internal chamber and an external keypad mounting area;
a primary printed circuit board mounted within the internal chamber;
a secondary printed circuit board mounted on the external keypad mounting area, the secondary printed circuit board being electrically coupled to the primary printed circuit board;
a plurality of switches on the secondary printed circuit board; and
a key pad including a plurality of keys mounted in a predetermined alignment over the plurality of switches so that the secondary printed circuit board is between the key pad and a surface of the external key pad mounting area and the switches are between the secondary printed circuit board and the key pad.

2. The device according to claim 1, wherein the external keypad mounting area includes an opening for a connector on the secondary printed circuit board to couple to a receiver on the primary printed circuit board.

3. The device according to claim 2, wherein the connector is a plurality of data pins and the receiver is a socket receiving the data pins.

4. The device according to claim 1, further comprising:
a frame including a plurality of holes in the predetermined alignment of the plurality of keys mounted over the key pad, the frame being secured to the external keypad mounting area.

5. The device according to claim 4, wherein a perimeter of the frame is secured to the external keypad mounting area.

6. The device according to claim 4, further comprising:
a frame overlay mounted over the frame.

7. The device according to claim 4, wherein the surface of the external keypad mounting area and a wall of the housing around the external keypad mounting area define a keypad receiving cavity so that when the cavity receives the secondary printed circuit board, the key pad and the frame, the frame is substantially in plane with an outer surface of the housing.

8. The device according to claim 1, further comprising:
an adhesive membrane mounted over the secondary printed circuit board sealing the secondary printed circuit board to the external keypad mounting area.

9. The device according to claim 1, wherein the device is one of an imager-based scanner, a laser-based scanner, a mobile phone, a calculator, a PDA, a tablet, a laptop and a copier.

10. A key pad arrangement for an electronic device, the key pad arrangement comprising:
a key pad receiving housing;
a printed circuit board mounted to a surface of the key pad receiving housing, the printed circuit board having an exposed electrical connector for establishing an electrical connection with a further printed circuit board of the electronic device, the further printed circuit board mounted within an internal chamber of the electronic device, the printed circuit board including a plurality of switches; and
a key pad including a plurality of keys mounted in a predetermined alignment over the plurality of switches so that the printed circuit board is between the key pad and the surface of the key pad receiving housing.

11. The arrangement according to claim 10, wherein the key pad receiving housing includes an opening for the electrical connector.

12. The arrangement according to claim 11, wherein the connector is a plurality of data pins.

13. The arrangement according to claim 10, further comprising:
a frame including a plurality of holes in the predetermined alignment of the plurality of keys mounted over the key pad, the frame being secured to the surface of the key pad receiving housing.

14. The arrangement according to claim 13, wherein a perimeter of the frame is secured to the surface of the key pad receiving housing.

15. The arrangement according to claim 13, further comprising:
a frame overlay mounted on the frame.

16. The arrangement according to claim 10, further comprising:
an adhesive membrane mounted over the printed circuit board sealing the printed circuit board to the surface of the key pad receiving housing.

17. The arrangement according to claim 10, wherein only a further electrical connector coupled to the further printed circuit board is exposed from the internal chamber, the further electrical connector receiving the exposed electrical connector of the printed circuit board.

18. A method for assembling a device, comprising:
providing a housing having an internal chamber and an external keypad mounting area;
mounting a primary printed circuit board within the internal chamber;
mounting a secondary printed circuit board on the external keypad mounting area, the secondary printed circuit board including a plurality of switches;
establishing an electrical connection between the primary and secondary printed circuit boards; and
mounting a key pad over the plurality of switches on the secondary printed circuit board, the key pad having a plurality of keys in a predetermined alignment so that the secondary printed circuit board is between the key pad and a surface of the external key pad mounting area and the switches are between the secondary printed circuit board and the key pad.

19. The method according to claim 18, further comprising:
mounting a frame over the key pad, the frame including a plurality of holes in the predetermined alignment of the plurality of keys.

20. The method according to claim 19, further comprising:
securing the frame to the external keypad mounting area.

21. The method according to claim 20, further comprising:
mounting a frame overlay over the frame.

22. The method according to claim 18, further comprising:
mounting an adhesive membrane over the secondary printed circuit board; and
securing the adhesive membrane to the external keypad mounting area.

23. A device, comprising:
a housing means providing an internal chamber and an external keypad mounting area;
a primary data processing means mounted within the internal chamber;
a secondary data processing means mounted on the external keypad mounting area, the secondary data processing means being electrically coupled to the primary data processing means;
a plurality of switch means on the secondary data processing means; and
an input means including a plurality of keys mounted in a predetermined alignment over the plurality of switch means so that the secondary data processing means is between the input means and a surface of the external key pad mounting area and the switch means are between the secondary data processing means and the input means.
